(19) United States
(12) Patent Application Publication
(10) Pub. No.: US 2022/0235891 A1
(43) Pub. Date: Jul. 28, 2022

(54) DUAL PLANE SEAL AIR CONDITIONER CONNECTOR

(71) Applicant: Hutchinson Fluid Management Systems. Inc., Auburn Hills, MI (US)

(72) Inventor: Robert J. Slais, Washington, MI (US)

(73) Assignee: Hutchinson Fluid Management Systems, Inc., Auburn Hills, MI (US)

(21) Appl. No.: 17/157,638

(22) Filed: Jan. 25, 2021

(51) Int. Cl. F16L 39/00; F16L 21/035

(52) U.S. Cl. CPC F16L 39/00; F16L 21/035

(57) ABSTRACT

A connector for providing a leak resistant flow path between fluid conduits includes a female connector, a male connector, and a tubular fluid conduit that extends through a conduit passage in the male connector and into a conduit receiving passage in the female connector. The connector can include optional anti-cantilever features that provide a more effective axial seal when using a seal washer recessed into a planar surface of the male connector to supplement a radial seal provided by an O-ring sealing member between the tubular fluid conduit and the conduit receiving passage.

### FIELD OF THE DISCLOSURE

This disclosure relates to connectors used in conduit systems for conveying refrigerants in air conditioning systems, and more particularly to a connector having multiple seals to reduce refrigerant leakage.

### BACKGROUND OF THE DISCLOSURE

It is highly desirable to reduce leakage of refrigerants from air conditioning systems to reduce emissions of greenhouse gases into the environment, to maintain the cooling capacity and functionality of the air conditioning systems, and to reduce maintenance. Moreover, the more environmentally friendly tetrafluoropropene (R1234yf) refrigerant, which is mandated for all NAFTA vehicles by the model year 2021, has a higher flammability rating than currently used refrigerants such as tetrafluoroethane (R134a), creating an additional incentive for preventing refrigerant leakage. Further, there are incentives to reduce refrigerant emissions in order to gain government issued carbon credits.

Connectors used in motorized vehicle applications typically comprise male and female connector blocks that are fastened together. These connectors typically employ a single fastener to simplify assembly and reduce time and labor. Such connectors are sometimes referred to as cantilevered conduit connectors because the fastener extends through a passage at an end of the connector opposite an end of the connector wherein the conduit passage is located, resulting in a non-uniform distribution of forces between the mating surfaces of the connector blocks. The uneven distribution of forces can cause the mating surfaces of the connector blocks to develop gaps that could allow an undesirable leakage around seals.

### SUMMARY OF THE DISCLOSURE

Disclosed is a dual plane seal connector designed to provide highly leak resistant engagement between tubular fluid conduits, while employing a single fastener. The connector includes a female connector block including a generally planar face having a conduit receiving passage in fluid communication with a second fluid conduit, and a male connector block having a generally planar face for abutting the generally planar face of the female connector. A counter-bored conduit passage is provided in the generally planar face of the male connector block. The counter-bored conduit passage includes a first cylindrical bore having a first diameter and a first depth and a second cylindrical bore coaxial with the first cylindrical bore. The second cylindrical bore has a second diameter greater than the first diameter and a second depth less than the first depth. A tubular fluid conduit extends through the conduit passage. A circumferential groove is defined in a portion of the tubular fluid conduit that protrudes outwardly from the conduit passage and away from the generally planar face of the male connector block and into the conduit receiving passage of the female connector block. A sealing ring is located in the groove to provide a radial seal, and a seal washer is located in the second cylindrical bore to provide an axial seal.

Together, these features provide a simple, inexpensive design that provides easy assembly, and reduced leakage due at least in part to the use of two independent seals, and at least in part to reduced opportunity for gaps between the mating faces of the connector blocks because the sealing washer is recessed into the face of the male connector.

### BRIEF DESCRIPTION OF THE DRAWINGS

FIG. 1 is a side cross-sectional view of a male connector block in accordance with this disclosure.

FIG. 2 is an end view of the male connector block shown in FIG. 1.

FIG. 3 is a side view of a female connector block in accordance with this disclosure.

FIG. 4 is a top view of the seal washer providing axial sealing between the male connector block and the female connector block.

FIG. 5 is a cross-sectional view of the seal washer as viewed along lines A-A of FIG. 4.

### DETAILED DESCRIPTION OF THE EMBODIMENTS

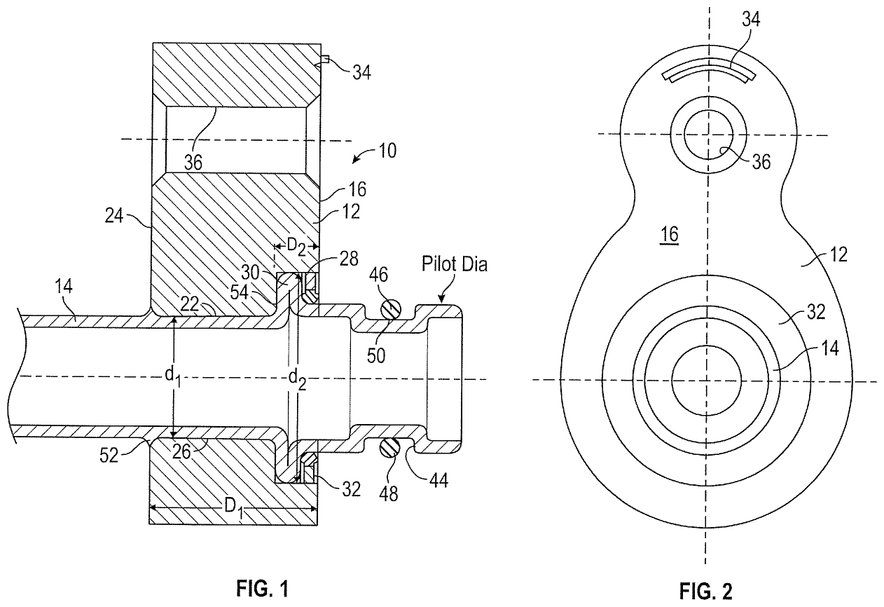

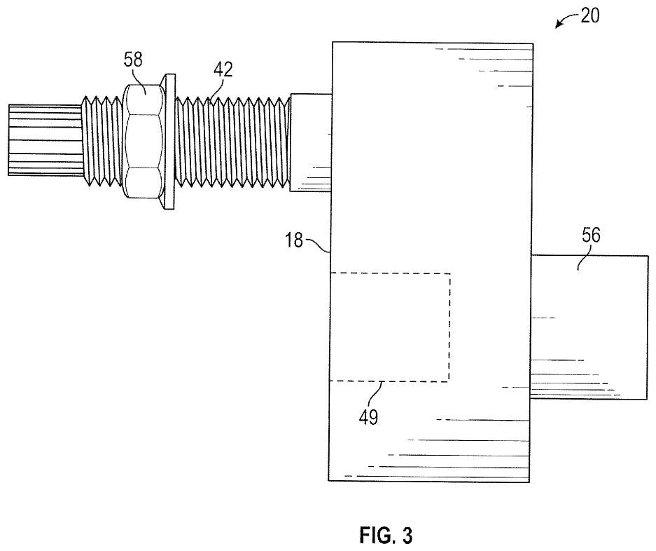

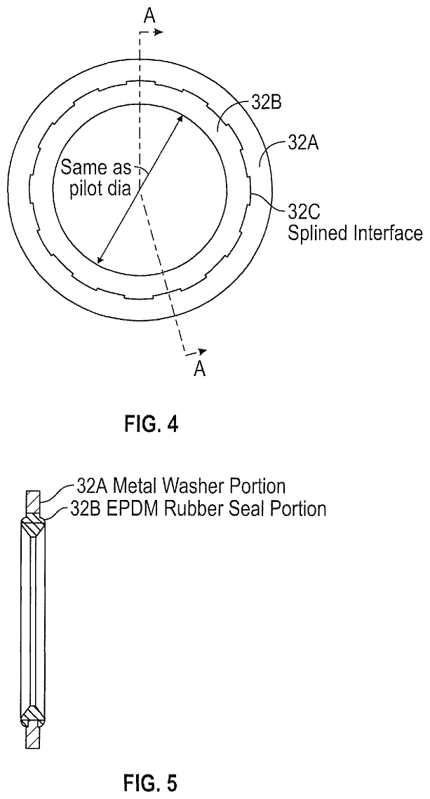

Shown in FIGS. 1 and 2 is a male connector block assembly 10, including a male connector block 12 and a tubular fluid conduit 14. Male connector block 12 has a generally planar face 16 for mating by abutting a generally planar face 18 of a female connector block 20 (FIG. 3). The expression “generally planar face” means that face 16 of block 12 (and face 18 of block 20) are mostly (more than 50%) flat, parallel to each other, and in contact with each other when the connector is fully assembled. A counter-bored conduit passage 22 extends through male connector block 20 from face 16 to a back side 24 of block 20. Passage 22 includes a first cylindrical bore 26 having a first diameter d₁ and a first depth D₁ (equal to the thickness of block 20), and a second cylindrical bore 28 having a second diameter d₂ and a second depth D₂. In the illustrated embodiment, the depth D₂ of the second cylindrical bore 28 is such that a crimped section 30 of conduit 14 and a seal washer 32 are accommodated, with the outwardly facing surface of seal washer 32 (i.e., the surface facing to the right in FIG. 1) being flush (i.e., level) with or coplanar with generally planar face 16 when it is compressed between male connector block 12 and female connector block 20. By using a round seal washer 32 disposed in a counter base (i.e., second cylindrical bore 28) on the generally planar face 16 of male connector block 12, as opposed to using a washer that is disposed between the entire area of generally planar faces 16 and 18 of blocks 12 and 20, cantilever (i.e., the tendency of the faces 16 and 18 to become skewed or non-parallel when fastened together) is reduced.

Optionally, a protuberance 34 can be provided on the generally planar face 16 of male connector block 12 to further reduce cantilever when male connector block 12 and female connector block 20 are fastened together. While protuberance 34 can be developed by machining the entire face 16 of block 12, protuberance 34 is preferably created by stamping or coining the face 16 adjacent to a fastener passage 36 to raise a predetermined amount of material to project away from face 16 (i.e., to the right in FIG. 1). The protuberance 34 can have a tapered shape that thins to a point in the outward direction (i.e., toward the right in FIG. 1). During assembly of the connection, the protuberance will create an anti-cantilever effect. The torque load caused by fastening blocks 12 and 20 together, such as with a nut tightened or torqued onto a threaded stud 42 that projects from the substantially planar face 18 of female connector block 20 and that passes through fastener passage 36 upon assembly of the connection, will slightly crush protuberance 34 tending to cause the faces 16 and 18 of blocks 12 and 20 to become parallel. As a result, gaps and unbalanced forces between faces 12 and 18 are avoided, thereby providing the best possible axial seal. The anti-cantilever effect of crushed protuberance 34 improves the consistency and adequacy of the axial seal by eliminating or reducing cantilevering effects caused by unpredictable dimensional variations of multiple components during manufacturing.

Tubular fluid conduit 14 is provided with a circumferential groove 44 on a portion of conduit 14 that protrudes outwardly from conduit passage 22 (i.e., to the right of face 16 in FIG. 1) and away from the generally planar face 16 of male connector block 12.

Located within circumferential groove 44 is a sealing ring 46 (e.g., an elastomeric O-ring). Sealing ring 46 includes an outward circumferential surface 48 contacting a surface of a conduit receiving passage 49 in female connector block 20, and an inward circumferential surface 50 sealingly contacting groove 44. Sealing ring 46 provides a radial seal between tubular fluid conduit 14 and conduit receiving passage 49 in female connector block 20.

As shown in FIG. 1, conduit 14 can be immobilized in the first cylindrical bore 26 of conduit passage 22 with spaced apart crimps 30 and 52. Crimp 30 engages a bottom surface 54 of second cylindrical bore 28, and crimp 52 engages a surface of back side 24 of block 20.

A single fastener can be used for forming a sealed connection between conduit 14 secured to male connector block 12 and a conduit 56 secured to female connector block 20. In the illustrated embodiment, female block 20 is provided with an integral threaded stud 42 that is adapted to pass through fastener passage 36. A nut 58 is used for compressing surfaces 16 and 18 together to form a fluid-tight connection. Fastener passage 36 is located between conduit passage 22 and protuberance 34.

Sealing ring 46 is preferably made of an elastomeric material. A preferred elastomeric material for sealing ring 46 is hydrogenated nitrile butadiene rubber (HNBR). Sealing ring 46 is preferably lubricated, such as with polyalkylene glycol (PAG oil) or silicon oil to allow sealing ring 46 to more easily slide along surfaces of conduit receiving passage 49 to avoid pinching and undesirable deformation of sealing ring 46 during assembly of a leak resistant connection. Alternatively, or additionally, sealing ring 46 can be provided with a polytetrafluoroethylene coating to eliminate or reduce unwanted pinching and other deformation of ring 46.

Seal washer 32 is preferably comprised of a metal (e.g., aluminum or steel) washer portion 32A that has a thickness approximately equal to the difference between the depth of counter bore 28 and the longitudinal thickness of crimped section 30, and an elastomeric portion 32B that can be made of the same elastomeric material used to make sealing ring 46, but is more preferably comprised of a different elastomer. In a particularly preferred embodiment, seal washer 32 is made of ethylene propylene diene monomer (EPDM) rubber. Having two different elastomeric materials used for washer 32 and ring 46, such as EPDM for washer 32 and HNBR for ring 46, provides better overall performance, especially under extreme conditions, such as extreme temperatures. For example, EPDM has better low temperature sealing capability and HNBR has better high temperature sealing capability. The metal washer portion 32A and elastomeric portion 32B can be mechanically joined such as with splines at interface 32C. Alternatively, or additionally, the washer portion and elastomeric portion of seal washer 32 can be chemically joined (e.g., with an adhesive material). The elastomeric portion 32B of seal washer 32 can have a tear-drop-like cross-sectional profile as shown in FIG. 5 that is compressed within the remaining space between crimp 30 and female connector block 20 that is not occupied by washer portion 32A upon complete assembly of the connection.

Conduit receiving passage 49 preferably has walls defined by a truncated conical shape, which leads sealing ring 46 into passage 46 with reduced pinching. As an example, the half angle of the truncated conical shape can be from about 5 degrees to 25 degrees, such as 10 degrees to 20 degrees, 15 degrees to 20 degrees, or about 18 degrees.

The combination of features provides a non-cantilever seal, wherein leakage past the O-ring 46 can be blocked by seal washer 32.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In summary, it should be understood that the invention is capable of modification and variation.

What is claimed is:

1. A male connector block assembly adapted to provide a fluid tight engagement between a tubular fluid conduit and a female connector block including a generally planar face having a conduit receiving passage in fluid communication with a second fluid conduit, comprising:
a male connector block having a generally planar face for abutting the generally planar face of the female connector, a counter-bored conduit passage in the generally planar face of the male connector block including a first cylindrical bore having a first diameter and a first depth and a second cylindrical bore coaxial with the first cylindrical bore having a second diameter greater than the first diameter and a second depth less than the first depth;
a tubular fluid conduit extending through the counter-bored conduit passage, a circumferential groove defined in a portion of the tubular fluid conduit protruding outwardly from the counter-bored conduit passage and away from the generally planar face of the male connector block;
a sealing ring located within the circumferential groove having an outward circumferential surface for sealingly contacting the conduit receiving passage of the female connector block and an inward circumferential surface sealingly contacting the outer circumferential groove of the tubular fluid conduit for providing a radial seal between the tubular fluid conduit and the conduit receiving passage of the female connector block; and
a seal washer located in the second cylindrical bore for providing an axial seal between the male connector block and the female connector block.

2. The assembly of claim 1, wherein the tubular fluid conduit is immobilized in the counter-bored conduit passage.

3. The assembly of claim 1, wherein the tubular fluid conduit is immobilized in the counter-bored conduit passage by two spaced apart crimps in the tubular fluid conduit, including a first crimp contacting a bottom surface of the second cylindrical bore in the male connector block and a second crimp contacting a surface on a side of the male connector block opposite of the generally planar face of the of the male connector block.

4. The assembly of claim 1, wherein the male connector block includes a single fastener passage for receiving a threaded stud that facilitates fastening of the male connector block to a female connector block.

5. The assembly of claim 4, wherein a protuberance projects from the generally planar face of the male connector block to more uniformly distribute forces between abutting generally planar faces of the male and female connector blocks.

6. The assembly of claim 5, wherein the fastener passage is located between the counter-bored conduit passage and the protuberance.

7. The assembly of claim 1, wherein the sealing ring is made of an elastomeric material.

8. The assembly of claim 1, wherein the sealing ring is made of an elastomeric material comprising hydrogenated nitrile butadiene rubber.

9. The assembly of claim 1, wherein the seal washer is made of an elastomeric material.

10. The assembly of claim 1, wherein the seal washer is made of an elastomeric material comprising ethylene propylene diene monomer rubber.

11. The assembly of claim 1, wherein the sealing ring is made of an elastomeric material comprising hydrogenated nitrile butadiene rubber, and the seal washer is made of an elastomeric material comprising ethylene propylene diene monomer rubber.

12. The assembly of claim 1, wherein the sealing ring is coated with polytetrafluoroethylene for reducing pinching and damage of the sealing ring during connection of the male connector block to the female connector block.

13. A connector for providing a fluid tight flow path between a first fluid conduit and a second fluid conduit, comprising:
a female connector block including a generally planar face having a conduit receiving passage in fluid communication with the second fluid conduit;
a male connector block having a generally planar face for abutting the generally
planar face of the female connector, a counter-bored conduit passage in the generally planar face of the male connector block including a first cylindrical bore having a first diameter and a first depth and a second cylindrical bore coaxial with the first cylindrical bore having a second diameter greater than the first diameter and a second depth less than the first depth;
a tubular fluid conduit extending through the counter-bored conduit passage, a circumferential groove defined in a portion of the tubular fluid conduit protruding outwardly from the counter-bored conduit passage and away from the generally planar face of the male connector block and into the conduit receiving passage of the female connector block;
a sealing ring located within the circumferential groove having an outward circumferential surface sealingly contacting the conduit receiving passage of the female connector block and an inward circumferential surface sealingly contacting the outer circumferential groove of the tubular fluid conduit for providing a radial seal between the tubular fluid conduit and the conduit receiving passage of the female connector block;
a seal washer located in the second cylindrical bore providing an axial seal between the male connector block and the female connector block; and
a fastener urging the substantially planar faces of the male and female connector blocks together.

14. The connector of claim 13, wherein the conduit receiving passage has a truncated conical shape to lead the sealing ring into the conduit receiving passage and reduce pinching of the sealing ring during connection of the male connector block to the female connector block.

15. The connector of claim 13, wherein the tubular fluid conduit is immobilized in the counter-bored conduit passage.

16. The connector of claim 13, wherein the tubular fluid conduit is immobilized in the counter-bored conduit passage by two spaced apart crimps in the tubular fluid conduit, including a first crimp contacting a bottom surface of the second cylindrical bore in the male connector block and a second crimp contacting a surface on a side of the male connector block opposite of the generally planar face of the of the male connector block.

17. The connector of claim 13, wherein the male connector block includes a single fastener passage for receiving a threaded stud that facilitates fastening of the male connector block to a female connector block.

18. The connector of claim 17, wherein a protuberance projects from the generally planar face of the male connector block to more uniformly distribute forces between abutting generally planar faces of the male and female connector blocks.

19. The connector of claim 18, wherein the fastener passage is located between the counter-bored conduit passage and the protuberance.

20. The connector of claim 13, wherein the sealing ring is made of an elastomeric material.

21. The connector of claim 13, wherein the sealing ring is made of an elastomeric material comprising hydrogenated nitrile butadiene rubber.

22. The connector of claim 13, wherein the seal washer is made of an elastomeric material.

23. The connector of claim 13, wherein the seal washer is made of an elastomeric material comprising ethylene propylene diene monomer rubber.

24. The connector of claim 13, wherein the sealing ring is made of an elastomeric material comprising hydrogenated nitrile butadiene rubber, and the seal washer is made of an elastomeric material comprising ethylene propylene diene monomer rubber.

25. The connector of claim 13, wherein the sealing ring is coated with polytetrafluoroethylene for reducing pinching and damage of the sealing ring during connection of the male connector block to the female connector block.
